(19) United States
(12) Patent Application Publication
(10) Pub. No.: US 2004/0201808 A1
(43) Pub. Date: Oct. 14, 2004

(54) Liquid crystal display and method of manufacturing the same

(75) Inventors: Kun-Hong Chen, Taipei Hsien (TW); Kuang-Chao Yeh, Ping Chen City (TW)

Correspondence Address: BRUCE H. TROXELL, SUITE 1404, 5205 LEESBURG PIKE, FALLS CHURCH, VA, 22041, US

(73) Assignee: AU Optronics Corp.

(21) Appl. No.: 10/458,782

(22) Filed: Jun. 11, 2003

(30) Foreign Application Priority Data
Apr. 11, 2003 (TW) 92108435

(51) Int. Cl. G02F 1/136

(52) U.S. Cl. 349/138

(57) ABSTRACT

A liquid crystal display (LCD) comprises an ILD layer formed on a glass substrate to cover a device made thereon. A first contact hole is formed in the ILD layer to expose partial surface of the device. An interconnecting layer is formed in the first contact hole to directly contact the device. A passivation layer is formed on the ILD layer and covers the interconnecting layer. A second contact hole is formed in the passivation layer to expose a portion of upper surface of the interconnecting layer. A planarizing film is formed on the passivation layer and covers side walls of the second contact hole completely, wherein a portion of bottom surface of the second contact hole is exposed. A pixel electrode is attached on the exposed bottom surface of the second contact hole to electrically connect to the interconnecting layer.

### FIELD OF THE INVENTION

The present invention relates to a display device, and more particularly, to an liquid crystal display (LCD) having lower contact resistance between the pixel electrode and interconnecting layer.

### BACKGROUND OF THE INVENTION

With the growth of information products such as notebooks, monitors, cell phones and personal digital assistants (PDAs), the demand for panels increases dramatically.

Referring to FIG. 1, it is a cross-sectional view of an LCD structure. A silicon-based island 14 with a source region 14s and a drain region 14d formed respectively in two ends is disposed on a glass substrate 12. Between the source region 14s and drain region 14d sandwiched a channel region 14c. A gate oxide film 16 is formed on the glass substrate 12 and covers the silicon-based island 14. A gate electrode 18 is arranged on a portion of the gate oxide film 16 over the channel region 14c. The gate electrode 18, gate oxide film 16 and silicon-based island 14 comprise a thin film transistor (TFT).

An interlayer dielectric (ILD) layer 20 is disposed on the glass substrate 12 and covers the TFT. First contact holes 21 are formed in the ILD layer 20 and gate oxide film 16 to expose portions of upper surfaces of the source region 14s and drain region 14d, respectively. An interconnecting layer 22 is formed in the first contact holes 21 to directly contact the source region 14s and drain region 14d.

A passivation layer 24 is formed on the ILD layer 20 and covers the interconnecting layer 22. A second contact hole 26 is fabricated in the passivation layer 24 to expose a portion of upper surface of the interconnecting layer 22 that is in direct contact with the source region 14s. A planarizing film 28 is formed on the passivation layer 24. In general, the thicknesses of the passivation layer 24 and planarizing film 28 are 1,000 to 5,000 Å and 10,000 to 50,000 Å, respectively.

A third contact hole 30 is fabricated in the planarizing film 28. The marked area of FIG. 1 is amplified in FIG. 2. Referring to FIG. 2, the third contact hole 30 is located over the second contact hole 26. In addition, the dimension of the third contact hole 30 is greater than that of the second contact hole 26. Thus, side walls of the second contact hole 26 are exposed.

Referring to FIG. 3, a pixel electrode 32 formed on the planarizing film 28 and laminated on surfaces of the third contact hole 30 and second contact hole 26 is electrically connected to the interconnecting layer 22 via the bottom surface of the second contact hole 26.

FIGS. 4-6 show steps of manufacturing the LCD structure mentioned above. Referring to FIG. 4, a silicon-based layer is deposited on a glass substrate 12. Next, the silicon-based layer is patterned to form a silicon-based island 14 on the glass substrate 12. Both ends of the silicon-based island 14 are then doped to form a source region 14s and a drain region 14d therein, respectively. After that, a gate oxide film 16 is formed by chemical vapor deposition (CVD) on the glass substrate 12 and covers the silicon-based island 14. A gate electrode 18 is formed on a portion of the gate oxide film 16 over the region 14c sandwiched between the source region 14s and drain region 14d. The gate electrode 18, gate oxide film 16 and silicon-based island 14 comprise a TFT.

Referring to FIG. 5, an ILD layer 20 is deposited on the glass substrate 12 and covers the TFT. Next, a plurality of first contact holes 21 are formed in the ILD layer 20 and gate oxide film 16 to expose portions of the upper surfaces of the source region 14s and drain region 14d, respectively. Then, an interconnecting layer 22 is formed in the first contact holes 21 to electrically connect to the source region 14s and drain region 14d.

Still referring to FIG. 5, a passivation layer 24 is deposited on the ILD layer 20 and covers the interconnecting layer 22. Then, a second contact hole 26 is formed in the passivation layer 24 over the interconnecting layer 22 that is in direct contact with the source region 14s to expose a portion of upper surface of the interconnecting layer 22. A planarizing film 28 is fabricated on the passivation layer 24 to flatten the surface. In general, the thickness of the passivation layer 24 is 1,000 to 5,000 Å, whereas the thickness of the planarizing film 28 is 10,000 to 50,000 Å.

Further still referring to FIG. 5, a third contact hole 30 is formed in the planarizing film 28 over the second contact hole 26. The dimension of the third contact hole 30 is greater than that of the second contact hole 26. Therefore, side walls of the second contact hole 26 are exposed. Referring to FIG. 6, a pixel electrode 32 formed on the planarizing film 28 and laminated on surfaces of the third contact hole 30 and second contact hole 26 is electrically connected to the interconnecting layer 22 via the bottom surface of the second hole 26.

However, a gas such as SF₆ used in the process of forming the aforementioned third contact hole 30 leads to damage the exposed passivation layer 24 in the second contact hole 26. In addition, the exposed passivation layer 24 in the second contact hole 26 adsorbs steam generated from the process. Further, referring to FIG. 7, the pixel electrode 32 is in direct contact with side walls of the planarizing film 28 in the third contact hole 30 and exposed passivation layer 24 in the second contact hole 26. Therefore, the deteriorated contact characteristic between the pixel electrode 32 and interconnecting layer 22 resulted in elevation of contact resistance.

### SUMMARY OF THE INVENTION

The present invention provides a display device with improved contact characteristic between a pixel electrode and an interconnecting layer, and a method for manufacturing the same. Moreover, the present invention provides a display device having lower contact resistance between a pixel electrode and an interconnecting layer.

An ILD layer is deposited on a glass substrate and covers TFTs fabricated thereon. Next, a first contact hole is formed in the ILD layer to expose a portion of upper surface of the TFT. An interconnecting layer formed in the first contact hole is electrically connected to the TFT. Then, a passivation layer is formed on the ILD layer and covers the interconnecting layer. A second contact hole is formed in the passivation layer to expose a portion of upper surface of the interconnecting layer that is in direct contact with the TFT. A planarizing film is formed on the passivation layer and covers side walls of the passivation layer in the second contact hole, whereas a portion of bottom surface of the second contact hole is still exposed. A pixel electrode is in direct contact with the interconnecting layer via the exposed bottom surface of the second contact hole.

### BRIEF DESCRIPTION OF THE DRAWINGS

The foregoing aspects and many of the attendant advantages of this invention will become more readily appreciated and understood by referencing the following detailed description in conjunction with the accompanying drawings, wherein:

FIG. 1 is a sectional view of an LCD in accordance with the prior art.

FIG. 2 is an amplification of the marked area shown in FIG. 1.

FIG. 3 is a sectional view of an LCD in accordance with the prior art.

FIGS. 4-6 show a method of making an LCD in accordance with the prior art.

FIG. 7 is an amplification of the marked area shown in FIG. 6.

FIG. 8 is a sectional view of an LCD in accordance with the present invention.

FIG. 9 is an amplification of the marked area shown in FIG. 8.

FIG. 10 is a sectional view of an LCD in accordance with the present invention.

FIGS. 11-13 show a method of making an LCD in accordance with the present invention.

FIG. 14 is an amplification of the marked area shown in FIG. 13.

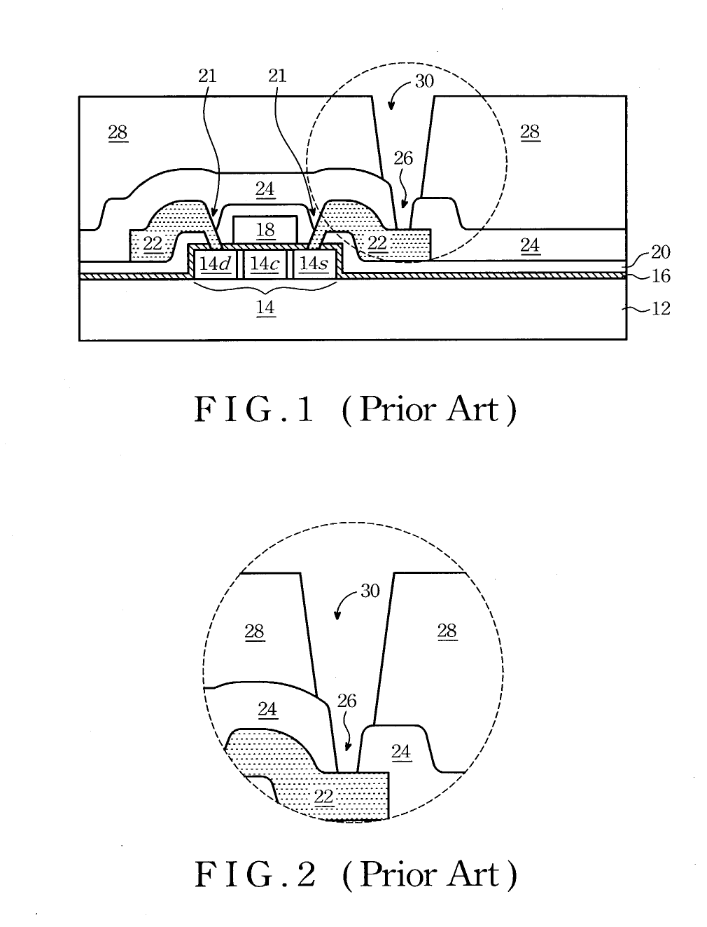

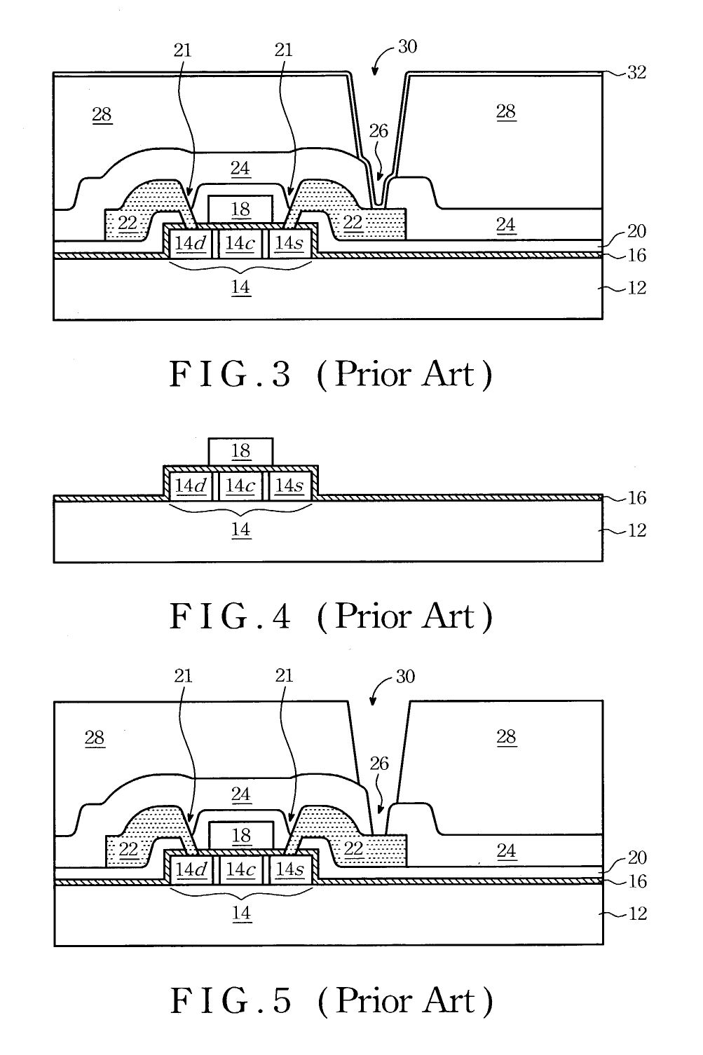

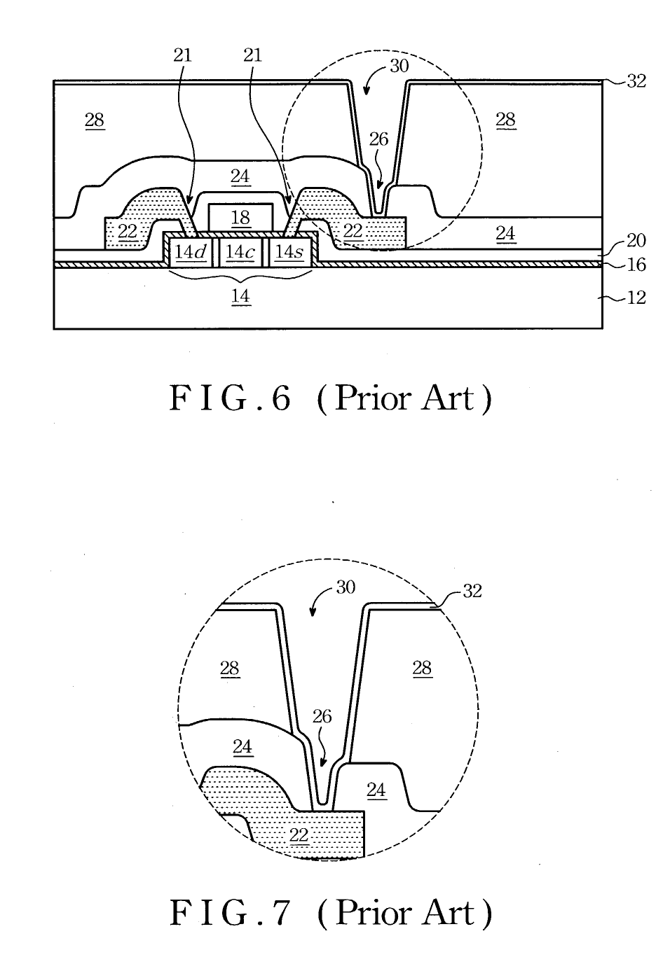

### DESCRIPTION OF THE PERFERRED EMBODIMENTS

The invention discloses an LCD and a method of manufacturing the same. The preferred embodiment of the present invention is now described in detail below.

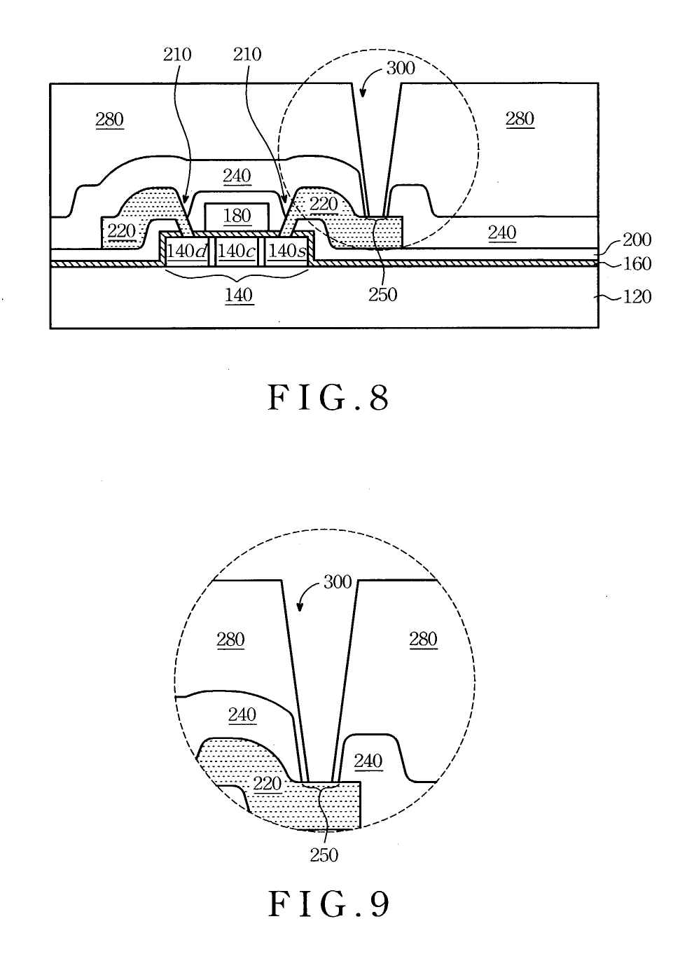

Referring to FIG. 8, an LCD structure is shown. A silicon-based island 140 is disposed on a glass substrate 120, wherein both ends of the silicon-based island 140 are doped to form a source region 140s and a drain region 140d therein, respectively. A channel region 140c is sandwiched between the source region 140s and drain region 140d. A gate oxide film 160 is formed on the glass substrate 120 and covers the silicon-based island 140. A gate electrode 180 is arranged on a portion of the gate oxide film 160 over the channel region 140c. The gate electrode 180, gate oxide film 160 and silicon-based island 140 comprise a thin film transistor (TFT).

An inter-layer dielectric (ILD) layer 200 is disposed on the glass substrate 120 and covers the TFT. A plurality of first contact holes 210 are formed in the ILD layer 200 and gate oxide film 160 to expose partial of the upper surfaces of the source region 140s and drain region 140d, respectively. An interconnecting layer 220 is formed in the first contact holes 210 to electrically connect to the source region 140s and drain region 140d of the TFT. The interconnecting layer 220 is preferably made of aluminum, titanium or any combination thereof.

A passivation layer 240 is formed on the ILD layer 200 and covers the interconnecting layer 220. The passivation layer 240 is used to protect the TFT covered therebeneath. A second contact hole 250 is fabricated in the passivation layer 240 to expose a portion of the upper surface of the interconnecting layer 220 that is in direct contact with the source region 140s. A planarizing film 280 is formed on the passivation layer 240 and fills the second contact hole 250. In one preferred embodiment of the present invention, the material of the passivation layer 240 is SiN, SiO or any combination thereof, and the planarizing film 280 is made of photosensitive materials. Thicknesses of the passivation layer 240 and planarizing film 280 are 1,000 to 5,000 Å and 10,000 to 50,000 Å, respectively.

Referring to FIG. 9, a third contact hole 300 is fabricated in the planarizing film 280. It is noted that the third contact hole 300 is located in the second contact hole 250, whereas a portion of bottom surface of the second contact hole 250 is exposed. Side walls of the passivation layer 240 in the second contact hole 250 are completely covered by the planarizing film 280.

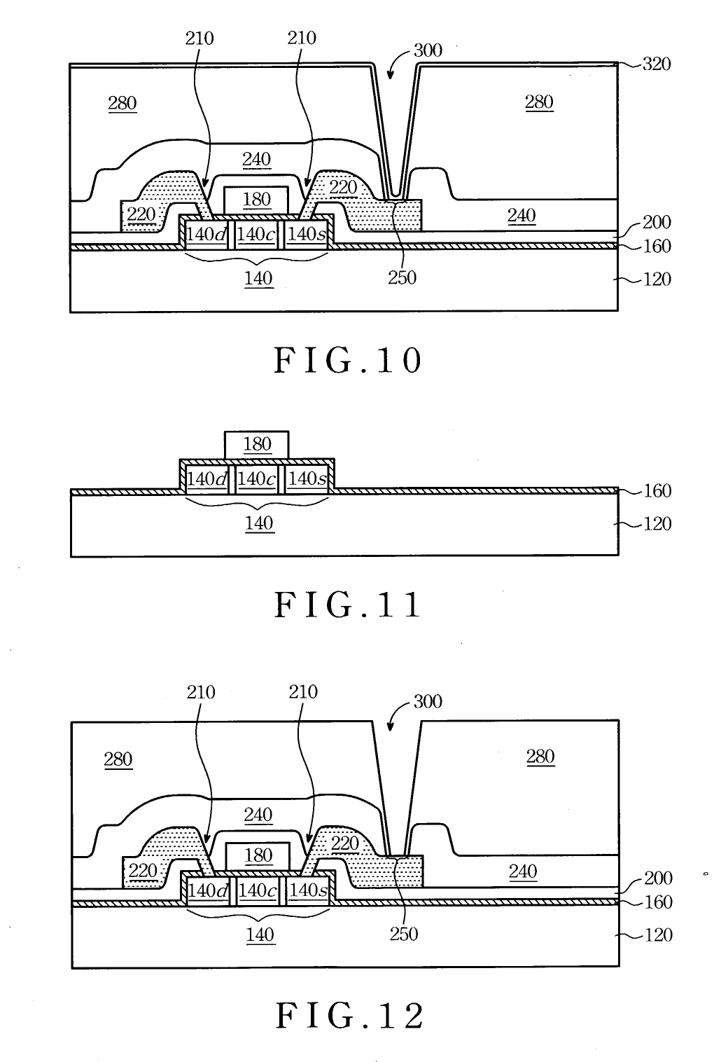

Referring to FIG. 10, a pixel electrode 320 formed on the planarizing film 280 and laminated on the surface of the third contact hole 300 is electrically connected to the interconnecting layer 220 via the bottom surface of the third contact hole 300. The pixel electrode 320 is preferably made of indium tin oxide (ITO).

FIGS. 11-13 show steps of manufacturing the LCD structure mentioned above. Referring to FIG. 11, a silicon-based layer is deposited on a glass substrate 120. Next, the silicon-based layer is patterned to form a silicon-based island 140 on the glass substrate 120. Both ends of the silicon-based island 140 are then doped to form a source region 140s and a drain region 140d therein, respectively. Thereafter, a gate oxide film 160 is formed by chemical vapor deposition (CVD) on the glass substrate 120 and covers the silicon-based island 140. A gate electrode 180 is formed on a portion of the gate oxide film 160 over the region 140c sandwiched between the source region 140s and drain region 140d. The gate electrode 180, gate oxide film 160 and silicon-based island 140 comprise a TFT.

Referring to FIG. 12, an ILD layer 200 is deposited on the glass substrate 120 and covers the TFT. Next, a plurality of first contact holes 210 are formed in the ILD layer 200 and gate oxide film 160 to expose portions of the upper surfaces of the source region 140s and drain region 140d, respectively. Then, an interconnecting layer 220 is formed in the first contact holes 210 to electrically contact with the source region 140s and drain region 140d.

Still referring to FIG. 12, a passivation layer 240 is deposited on the ILD layer 200 and covers the interconnecting layer 220. In a preferred embodiment of the present invention, the passivation layer 240 is made of SiN, SiO or any combination thereof. In addition, the thickness of the passivation layer 240 is 1,000 to 5,000 Å. Then, a second contact hole 250 is formed in the passivation layer 240 to expose a portion of upper surface of the interconnecting layer 220 that is in direct contact with the source region 140s. Next, a planarizing film 280 is fabricated on the passivation layer 240 and fills the second contact hole 250. The planarizing film 280 is used to elevate the open ratio and avoid the parasitic capacitance.

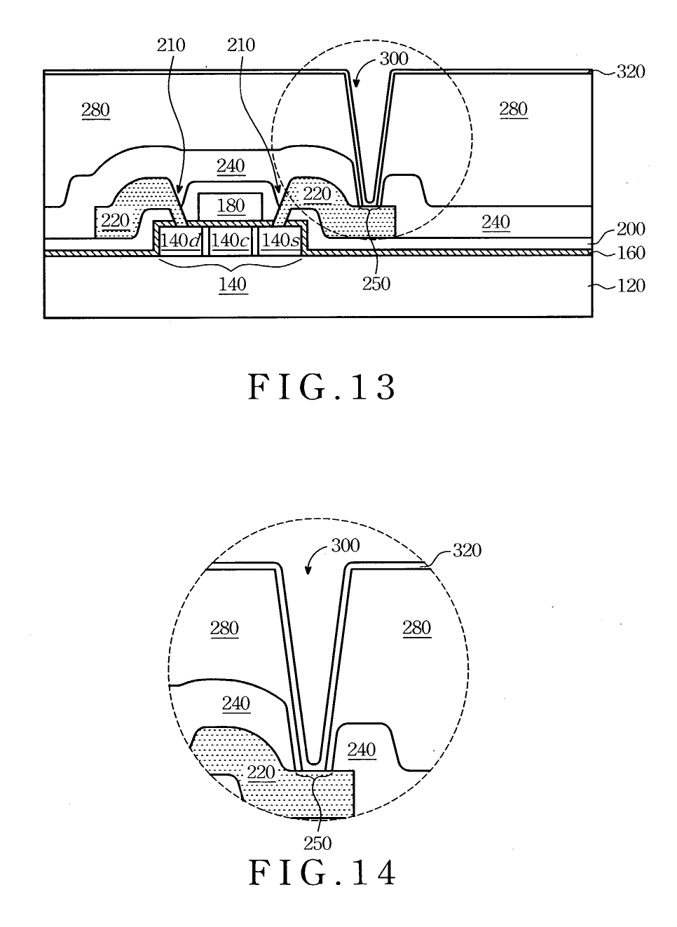

Subsequently, a third contact hole 300 is formed in the planarizing film 280. Further still referring to FIG. 12, the third contact hole 300 is located in the second contact hole 250, whereas a portion of bottom surface of the second contact hole 250 (i.e. a portion of the upper surface of the interconnecting layer 220 that is electricaaly connected to the source region 140s) is exposed. It is noted that side walls of the second contact hole 250 are completely covered by the planarizing film 280. In one preferred embodiment of the present invention, the planarizing film 280 is made of photosensitive materials and the thickness thereof is 10,000 to 50,000 Å. In addition, the third contact hole 300 is formed by development, etching or the combination thereof. Referring to FIG. 13, a pixel electrode 320 formed on the planarizing film 280 and attached on the surface of the third contact hole 300 is electrically connected to the interconnecting layer 220. In general, the pixel electrode 320 is made of ITO.

In the above description, side walls of the passivation layer in the second contact hole are covered by the planarizing film completely so that the passivation layer is avoided being damaged by the gas such as SF₆ used in the procedure of forming the third contact hole in the planarizing film. In addition, the pixel electrode is only in direct contact with the planarizing film in the third contact hole, thus the contact characteristic between the pixel electrode and interconnecting layer is improved to lower the contact resistance.

While the preferred embodiment of the invention has been illustrated and described, it is appreciated that modifications and variations can be made therein without departing from the spirit and scope of the invention. For example, the top gate described in the present invention can be replaced with a bottom gate.

What is claimed is:

1. A liquid crystal display, comprising:
an ILD layer formed on a glass substrate and covering a device fabricated thereon;
a first contact hole through said ILD layer;
an interconnecting layer formed in said first contact hole to electrically connect to said device;
a passivation layer formed on said ILD layer and covering said interconnecting layer;
a second contact hole through said passivation layer to expose a portion of upper surface of said interconnecting layer;
a planarizing film covering side walls of said second contact hole, and at least a portion of bottom surface of said second contact hole being exposed; and
a pixel electrode being electrically connected to said interconnecting layer via the exposed bottom surface of said second contact hole.

2. The liquid crystal display of claim 1, wherein said device comprises a thin film transistor.

3. The liquid crystal display of claim 1, wherein said passivation layer is made of SiN, SiO or any combination thereof.

4. The liquid crystal display of claim 1, wherein said planarizing film is made of photosensitive materials.

5. The liquid crystal display of claim 1, wherein said interconnecting layer is made of aluminum, titanium or any combination thereof.

6. A liquid crystal display, comprising:
an ILD layer formed on a glass substrate and covering a thin film transistor fabricated thereon;
a first contact hole through said ILD layer;
an interconnecting layer formed in said first contact hole to electrically connect to said thin film transistor;
a passivation layer formed on said ILD layer and covering said interconnecting layer;
a second contact hole through said passivation layer to expose a portion of upper surface of said interconnecting layer;
a planarizing film covering side walls of said second contact hole, and at least a portion of bottom surface of said second contact hole being exposed; and
a pixel electrode being electrically connected to said interconnecting layer via the exposed bottom surface of said second contact hole.

7. The liquid crystal display of claim 6, wherein said passivation layer is made of SiN, SiO or any combination thereof.

8. The liquid crystal display of claim 6, wherein said planarizing film is made of photosensitive materials.

9. The liquid crystal display of claim 6, wherein said interconnecting layer is made of aluminum, titanium or any combination thereof.

10. A method for manufacturing a liquid crystal display, comprising:
forming an ILD layer on a glass substrate and covering a device fabricated thereon;
forming a first contact hole in said ILD layer to expose a portion of upper surface of said device;
forming an interconnecting layer in said first contact hole to electrically connect to said device;
forming a passivation layer on said ILD layer and covering said interconnecting layer;
forming a second contact hole in said passivation layer to expose a portion of upper surface of said interconnecting layer;
forming a planarizing film on said passivation layer and filling said second contact hole;
forming a third contact hole in said planarizing film to expose a portion of bottom surface of said second contact hole, wherein side walls of said second contact hole are completely covered by said planarizing film; and
forming a pixel electrode on said planarizing film and covering the surface of said third contact hole to electrically connect to said interconnecting layer.

11. The method of claim 10, wherein said device comprises a thin film transistor.

12. The method of claim 10, wherein said passivation layer is made of SiN, SiO or any combination thereof.

13. The method of claim 10, wherein said planarizing film is made of photosensitive materials.

14. The method of claim 10, wherein said interconnecting layer is made of aluminum, titanium or any combination thereof.

15. The method of claim 10, wherein said third contact hole is formed by development, etching or the combination thereof.

16. A method of manufacturing an LCD, comprising:
forming an ILD layer on a glass substrate and covering a thin film transistor fabricated thereon;
forming a first contact hole in said ILD layer to expose a portion of upper surface of said thin film transistor;
forming an interconnecting layer in said first contact hole to electrically connect to said thin film transistor;
forming a passivation layer on said ILD layer and covering said interconnecting layer;
forming a second contact hole in said passivation layer to expose a portion of upper surface of said interconnecting layer;
forming a planarizing film on said passivation layer and filling said second contact hole;
forming a third contact hole in said planarizing film to expose a portion of bottom surface of said second contact hole, wherein side walls of said second contact hole are completely covered by said planarizing film; and
forming a pixel electrode on said planarizing film and covering the surface of said third contact hole to electrically connect to said interconnecting layer.

17. The method of claim 16, wherein said passivation layer is made of SiN, SiO or any combination thereof.

18. The method of claim 16, wherein said planarizing film is made of photosensitive materials.

19. The method of claim 16, wherein said interconnecting layer is made of aluminum, titanium or any combination thereof.

20. The method of claim 16, wherein said third contact hole is formed by development, etching or the combination thereof.
